(19) United States
(12) Patent Application Publication
(10) Pub. No.: US 2023/0309592 A1
(43) Pub. Date: Oct. 5, 2023

(54) METHOD FOR PRODUCING A PAR-FRIED CHIP

(71) Applicant: Kieran WALL, Cork (IE)

(72) Inventor: Kieran WALL, Cork (IE)

(21) Appl. No.: 18/041,990

(22) PCT Filed: Aug. 16, 2021
(86) PCT No.: PCT/EP2021/072760

§ 371 Date: Feb. 16, 2023

(30) Foreign Application Priority Data
Aug. 16, 2020 (EP) 20191240.9

(51) Int. Cl. A23L 19/18; A23L 5/10; A23L 3/36

(52) U.S. Cl. CPC A23L 19/18; A23L 5/11; A23L 3/36

(57) ABSTRACT

Provided is a method for producing a par-fried chip that retains the desirable qualities, such as taste and texture, of a fresh prepared deep fried chips when oven cooked. The method comprises immersing an amount of raw potato strips in water to increase moisture content and par-frying said strips.

### FIELD OF THE INVENTION

The current invention relates to methods for producing chips. In particular, the invention relates to a method for producing a par-fried chip that retains the desirable qualities, such as taste and texture, of fresh prepared deep fried chips when oven cooked.

### BACKGROUND OF THE INVENTION

Chips, or more commonly referred to as “French fries”, made from potatoes, are one of the most popular convenience foods with a wide variation produced for both foodservice and domestic consumption. Chips are served in most traditional and fast food restaurants and cafes. The use of chilled, or frozen, par-fried chips has been widely adopted in most restaurants because of the advantages they offer. Some of the advantages associated with the use of chilled, or frozen, par-fried chips are that users know in advance the exact costs, the number of servings and the cost per portion. In addition, the use of the chilled, or frozen, par-fried chips simplifies storage and inventory control, assures uniform quality from one season to another and reduces labour and time preparation for serving. Their use at home is also widespread for similar reasons but more so for the convenience they offer instead of preparing fresh chips.

A major problem confronted by both domestic and food service consumers is obtaining oven finished chips that have similar taste and texture of chips finished by deep frying. Important features of chips finished by deep frying are interior fluffiness and moistness along with a crispy crust. However, achieving these product characteristics has not been possible when the products are oven finished. Oven finished products are typically leathery, tough, and drier than chips finished by deep frying in hot oil or fat.

Trying to replicate the crispiness of deep fried chips with oven chips is extremely difficult as par-fried oven chips are typically par-fried just once, at a low temperature between 130° C. and 150° C., whereas chips served from a traditional fast food restaurant for example, are typically fried twice, once at a low temperature between 130° C. and 150° C. to cook the inside of the chip and then a second time at a higher temperature of from 170° C. to 190° C. to crisp the chip on the outside. These double fried chips would typically contain fat levels of over 10%.

Several groups have aimed to provide par-fried potato products, which when oven finished, have the same textural attributes of deep-fried chips.

WO9740708 discloses a method to provide frozen par-fried potatoes with a final moisture content before oven cooking of between 38% and 58%. This method comprises an initial step of reducing the moisture content of the potato strip or “raw chip” to not less than about 60% by dehydrating the strip and then frying the strip in oil at a temperature of about 132° C. to about 168° C. for a period of time to reduce the moisture content to about 38% to about 58%. The par-fried chips are subsequently frozen. Prior to frying, the chips are blanched in hot water to inactivate the enzymes and remove excess free sugars from the surface.

U.S. Pat. No. 4,931,296 discloses a process for producing a potato product, which upon reheating in a conventional microwave oven, resembles the size shape appearance, colour, texture, taste, aroma, and eating experience of a French-fried potato product. The potato strips are dust coated with a layer of potato granules and fried to achieve a moisture content of about 20% to 40% by weight. The strips are then cooled and frozen.

WO9740712 discloses par-fried potato strips suitable for oven finishing. The strips have about 34% to 58% bulk moisture and about 8 to about 30% fat. The strips have a uniform surface coating of oil or fat. The method disclosed comprise a step of washing the raw strips to remove surface starch and subsequently blanching the strips. The method comprises a step of frying the strips at a temperature of about 132° C. to about 196° C. to achieve a bulk moisture level of about 38% to about 58%. The chips are then blast frozen.

U.S. Pat. No. 6,042,840 discloses the production of par-fried potato strips comprising par-frying strips in oil at a temperature of 132° C. to about 196° C. for a time sufficient to reduce the moisture content of the fries to 30% to 50%, hydrating the surface by application of water or aqueous solution dispersion until the weight is increased from about 1% to about 12%, and freezing the par-fries, having a bulk moisture of from about 35% to about 55%. The potato strips are blanched prior to par-frying.

US2019/075828 discloses a method for making chips in which potatoes are washed and then blanched, using ion blanching, in water at a temperature of around 95° C. The water has an ion solution in it to destruct enzyme activity and prevent enzymatic browning of the potato chip. This step also decreases the moisture content of the potato chip. The potato chips are rinsed and then treated to provide a coating using a solution of gaur gum and sorbitol at a temperature of 50° C., before frying.

WO2007/033416 discloses a method for making chips in which peeled potato strips are immersed in a water bath at 25° C. for 2 minutes and subjected to ultrasound field transducers. This step is carried out to modify the cellular structure. The strips are blanched at a high temperature before frying and drying. These steps reduce the moisture content of the strips.

AU2011203259 discloses a method for making chips comprising the use of an asparagine-reducing enzyme. The method involves cutting peeled potatoes into strips and blanching the strips at a high temperature, e.g., 70° C. to 90° C. In one embodiment, the strips are then placed in tap water for around 10 seconds and dried before par-frying at a temperature of around 190° C. After the blanching steps the chips are added to an asparaginase solution to reduce the final acrylamide content. In another embodiment, the strips are dried in a heating chamber (85° C.) before par-frying and drying. A similar method is disclosed by WO2006053563.

EP1419702 discloses a method for preventing acrylamide formation in heat treated food. One food mentioned is a potato. The method for producing fried potato crisps with reduced acrylamide content comprises a step of blanching for 5 to 10 minutes with the addition of salt or salts and with metal-ions removal. The strips are then air swept and dried before deep fat frying.

U.S. Pat. No. 3,934,046 discloses a method of making a chip comprising pre-frying potatoes and subsequently leeching the potatoes by contacting them with water by spraying or immersing in water at a temperature from freezing to boiling. The authors state that the usual temperature range of this step is around 37° C. to 65° C. The step of pre-frying the potatoes reduces the moisture content and leeching reverse the effects of browning where fried potatoes products are dark coloured after they are fried. The potatoes are finished fried (162° C. to 190° C.) and packaged. The aim of this method is to control browning and not moisture content.

Such prior art methods include steps such as blanching, dehydration, pre-frying, or forced hot air drying, to rapidly reduce moisture content to much lower levels, typically 20-60%, to reduce the final cooking time in the oven. The disadvantage of having par fried chips with such low moisture levels is that following the final cooking stage in the oven the chips will have further lost a substantial amount of moisture resulting in chips that are very dry on the inside with a tough, hard, leathery skin. To offset this problem, such prior art methods also include for the use of additives, flavouring and various treatments to enhance their flavour, appearance, and texture.

It is an object of the invention to overcome at least one of the above-referenced problems by providing a method for producing a par fried chip that has a similar taste and texture to deep fried chips when oven cooked, and which does not require the use of flavourings or other additives. In contrast to the prior art, the method of the invention naturally manipulates moisture content by soaking potato chips, preferably untreated, with a high moisture content, in water at a temperature of room temperature or below.

### SUMMARY OF THE INVENTION

The method of the current invention produces par-fried chips, which when cooked in an oven, preferably a fan oven, or alternatively, cooked by frying, in a deep fryer or air fryer for example, retain the desirable qualities of chips made from freshly cut potatoes which are deep fried and typically served from traditional fast food restaurants, i.e. crispy on the outside but fluffy and moist on the inside. Preferably, the par-fried chips are chilled.

The current inventors have surprisingly discovered that controlling moisture levels and the rate of moisture loss during manufacture ensures that the chilled par-fried chips have these qualities when finished in the oven or alternatively, when fried.

The chips produced by the method of the invention are produced without the use of additives, flavourings or preservatives and have a low fat content, typically less than 6%, most preferably less than 3%. The par-fried chips are preferably chilled instead of being frozen to maintain product freshness as much as possible, but it is possible to freeze the par-fried chips produced by the method of the invention. Further, when oven finished, the chips show a vast improvement in flavour when compared to commercially prepared chilled, or frozen, par-fried chips of the prior art, which have been oven finished.

As previously mentioned, methods of the prior art are based on the premise of reducing moisture to levels between 20% and 60% prior to oven baking. In contrast, the method of the invention does not involve blanching, dehydration, or other means of forced hot air drying, to reduce moisture levels. In contrast, the current method uses natural manipulation of the moisture content by varying the process times and temperatures and including a water immersion step. This serves to increase the moisture content of the raw potato strip(s) to allow for the subsequent losses of moisture during par frying and oven cooking. The current inventors are the first to implement such a method. No method of the prior art comprises a step of immersing raw potato chips with a high moisture content in water to increase the water content prior to par-frying.

A first aspect of the invention provides a method of producing a par-fried chip, the method comprising increasing the moisture content of an amount of raw potato strips and par-frying the strips in oil. The moisture content of the raw potato strips may be increased by immersing the raw potato strips in water.

The invention provides a method of producing a par-fried chip, the method comprising the steps of:
(i) immersing an amount of raw potato strips having a moisture content in a range of from about 70% to about 85%, in water.
(ii) par-frying the strips in oil to achieve a par-fried chip with a moisture content in a range of from about 65% to about 85%.

The raw potato strips are immersed in water to increase the moisture content of the strip(s). Preferably, the raw potato strips are immersed in water to increase the moisture content by at least 2%, preferably at least 5%.

Preferably, in step (i) the strips are soaked or immersed in water to achieve a moisture content in a range of from about 80% to about 90%, typically in a range of from 82% to 87%.

Typically, the potato strips are immersed in cold or chilled water for at least 5 minutes, preferably at least 20 minutes, or notably at least 60 minutes. For example, from about 30 minutes to about 120 minutes. In an embodiment, the chips are immersed for a period from 30 minutes to 90 minutes.

Preferably, in step (i) the water has a temperature of less than 25° C., preferably less than 20° C. Still preferred, the water has a temperature in a range of from −5° C. to 20° C., notably, from −5 to 15° C., or −2° C. to 10° C. or 5° C.

Preferably, the moisture content of the raw potato strip prior to immersing or soaking is in a range of from about 77% to about 80%, most preferably a moisture content in a range of about 78% to 79%. Notably, about 75%, 76%, 77%, 78%, 79%, 80%, or 81%.

Preferably, in step (ii) the strips are par-fried in oil at a temperature in a range of from 125° C. to 165° C., typically at a temperature from 130° C. to 150° C.

In an embodiment, the potato strips are selected from the group comprising but not limited to the species Solanum tuberosum L. cv. Markies, (“Markies potatoes”), Maris Piper, King Edward, Accord, Agria, Cabaret, Challenger, Performer, Russet Burbank and Victoria. Preferably, the potato strips are from Markies potatoes.

In an embodiment, the oil is beef dripping or coconut oil.

Optionally, the raw potato strips are rinsed with water prior to step (i). Rinsing may be by spraying.

In an embodiment, the chips are rinsed with water after step (i). Rinsing may be by spraying.

In an embodiment, the method further comprises a step of drying the surface of the raw strip prior to step (ii). Typically, this is achieved by blowing or removing excess water off the surface, preferably by passing the raw strips under a device suitable for this function, such as an air knife/blade. This step is preferably carried out at room temperature. The raw strips may be air dried at room temperature.

In an embodiment, the method further comprises a step of cooling the chips to a temperature of less than 10° C., typically in a range of between −2° C. and 10° C., or from 0° C. to 8° C., after par-frying prior to packaging. Optionally, the chips are agitating during cooling.

Preferably, the method step of cooling the chips comprises blast chilling the chips to a temperature of less than 10° C., typically in a range of between −2° C. and 10° C. after par-frying

In an embodiment, the chips are frozen after par-frying. The chips may be chilled before freezing.

A par-fried chip obtained or produced by the method of the invention is also provided.

A par-fried chip with a moisture content in a range of from about 65% to about 85%, typically about 73% to about 80% or 78%.

The invention provides a method of producing a par-fried chip, the method comprising the steps of: par-frying an amount of raw potato strips having a moisture content from about 70% to about 85%, in oil to achieve a par-fried chip with a moisture content of between about 65% to about 85%. The preferred embodiments discussed in relation to the first method of the invention also apply to this method.

### Definitions and General Preferences

Where used herein and unless specifically indicated otherwise, the following terms are intended to have the following meanings in addition to any broader (or narrower) meanings the terms might enjoy in the art:

Unless otherwise required by context, the use herein of the singular is to be read to include the plural and vice versa. The term “a” or “an” used in relation to an entity is to be read to refer to one or more of that entity. As such, the terms “a” (or “an”), “one or more,” and “at least one” are used interchangeably herein.

As used herein, the term “comprise,” or variations thereof such as “comprises” or “comprising,” are to be read to indicate the inclusion of any recited integer (e.g., a feature, element, characteristic, property, method/process step or limitation) or group of integers (e.g., features, element, characteristics, properties, method/process steps or limitations) but not the exclusion of any other integer or group of integers. Thus, as used herein the term “comprising” is inclusive or open-ended and does not exclude additional, unrecited integers or method/process steps.

As used herein the term “par-fried” refers to a process by which a product such as a chip or potato strip, has been subjected to at least one frying process, but which has not been completely or fully cooked.

As used herein the term “moisture content” refers to the quantity of water contained in a material, in this context, the strip or chip. It is typically expressed as a %. Methods and techniques to measure moisture content of a food product are known in the art. In this context, the moisture content of the raw potato strip may be measured gravimetrically, and such methods are known in the art. A moisture balance uses the gravimetric moisture measurement principle, also referred to as thermogravimetric or loss on drying (LOD). The moisture balance employs one of the most exact methods available for moisture determination. The moisture balance also provides a lot of flexibility, as gravimetric moisture measurement is not material dependent. This means that no material characteristics or presets must be saved by the gravimetric moisture balance. Instead, gravimetric moisture measurement relies on sample weight. To begin, a sample is weighed with a precision scale. The sample is then dried and weighed repeatedly until the sample shows no fluctuation in weight. The sample's weight after the drying process concluded is compared against the sample's weight before drying. In addition, the weights recorded during the drying process are taken into account and a final moisture content or ratio for the material sample is obtained. The key is to heat the sample just enough so the material releases moisture without burning. Therefore, the temperature has to be adjusted to accommodate the heat tolerance of the sample material. The moisture content of the cooked or par-fried chips may be measured by CEM SMART SYSTEM (https://cem.com/en/smart-6).

As used herein the term “dry matter content” is a measurement of the mass of an object when completely dried. It is typically expressed as a %. Dry matter content is the inverse of the moisture content.

As used herein the term “blast chilling” is a method of cooling food rapidly to a low temperature that is safe from bacterial growth, e.g., in the case of this invention between −2° C. and 10° C.

As used herein the term “uncoated” refers to a potato strip(s) which does not comprise a coating of an additive or similar substance.

As used herein the term “blanched or blanching” refers to a process by which a potato chip or strip is immersed in hot water, preferably at least 50° C. for a short period of time, e.g., 2 to 3 minutes. Preferably, the water is around 100° C.

As used herein the term “raw” potato strip or chip refers to a strip of potato that has been uncooked, including not pre-fried, par-fried, blanched or otherwise heat treated in any way.

### DETAILED DESCRIPTION

All publications, patents, patent applications and other references mentioned herein are hereby incorporated by reference in their entireties for all purposes as if each individual publication, patent or patent application were specifically and individually indicated to be incorporated by reference and the content thereof recited in full.

The current invention relates to a method for producing a par fried chip that has a similar taste and texture to freshly prepared deep-fried chips when oven cooked. The method may produce chips without using additives or flavourings or preservatives. In other words, the chips are untreated with additives, flavourings or preservatives. The chips or strips used in the method are uncoated, e.g., with any additive, flavouring or preservative. Additives, flavourings, and preservatives are known in the art. Examples of additives commonly used in chips or par-fried chips include but are not limited to dextrose, sodium acid pyrophosphate E450, turmeric extract, annatto, paprika extract, guar gum, sorbitol and starch. Examples of preservatives include but are not limited to citric acid, sodium metabisulphite, salt (NaOH), and ascorbic acid. Examples of flavourings include but are not limited to dextrose, dextrin, and artificial flavourings i.e., beef flavouring.

As there are only two ingredients used, potatoes and oil, such as beef dripping/coconut oil, there is no way to mask any undesirable flavours or textures. The chips produced by this method contain a lower rate of fat, preferably less than 6%, or between 1% and 6%, most preferred less than 3% or 2%. The chips are fried only once, compared with traditional chips from fast food restaurants, which are generally fried twice and have a much higher fat content.

As discussed, controlling the moisture levels to prevent a large reduction in moisture during production of the par-fried chip is critical to the quality of the end product. This is in contrast to the prior art methods, which aim to reduce the moisture content of the strips.

The inventors have surprisingly discovered that to achieve the optimum level of fluffiness and moistness on the inside, chips should preferably have a moisture content of between 55% and 70%, most preferably between 60% and 65%, when taken out of the oven. The current inventors determined that the average time taken to crisp the outside of a chip sufficiently was approximately 15 minutes in a fan oven at 220° C. However, during this time the chip lost between 13% to 15% moisture. During the frying phase the reduction in moisture level was determined to be between 8% to 12%. The inventors concluded that the target moisture level for par-fried chips was between 65% and 85%, most preferably, 73% to 80%, in order to achieve the desired end product.

The starting moisture content of the raw potatoes used to make the chips was seen as being crucial to delivering the desired end product. The inventors experimented using raw potatoes of varying levels of moisture. They started with potatoes of relatively high moisture levels of over 85% in order to overcome the subsequent losses incurred during par frying and in the oven, but because of their low level of dry matter/starch content, they made chips that were above the desired moisture range of 55%-70% when finished in the oven resulting in them being quiet limp and soggy.

However, when raw potatoes with relatively low moisture contents of between 70% and 80%, were par fried, chilled and then put into a fan oven at 220° C. for 15 minutes, then they would end up lower than the desired range of 55%-70% when finished in the oven. This resulted in chips with a hard crust on the outside and very dry and over cooked on the inside.

In overcoming this problem, the method includes a step of immersing, or soaking, the raw strips after cutting, preferably immediately after cutting, in water. The aim of this step is to increase the moisture content of the raw potato strip(s) to allow for the subsequent losses of moisture during par frying and oven cooking, preferably by at least 2%, typically at least 5%. Desirably, the moisture content is increased by an amount in the range of from 1% to 15%, typically from about 5% to 10%. It may be by, or at least, 3%, 4%, 5%, 6%, 7%, 8%, 9%, 10%, 11%, 12%, 13% or 14%. The duration of this step is varied depending on the starting moisture content of the raw strip. Typically, the strips are fully immersed in water. It may be carried out using any suitable apparatus or system, such as a tank. In an embodiment of the current invention, strips are immersed for a time period sufficient to increase the moisture content to an amount in the range of about 80% to 90%, preferably, 81% to 89%, or 82% to 87%, preferably to one from 83% to 85%, or 84%. Notably, the moisture content is increased to 80%, 81%, 82%, 83%, 84%, 85%, 86%, 87%, 88%, 89% or 90%.

The immersion time is at least 5 minutes, at least 10 minutes, at least 15 minutes, preferably equal to or at least 20 minutes. It may be for a time period between 30 minutes and 180 minutes or from 30 minutes to 120 minutes. The time period may be one from 40 minutes and 100 minutes, or 40 minutes to 80 minutes, or from 50 minutes to 60 minutes. Soaking in cold water was found to increase the moisture content of the chips as they absorbed moisture under their surface but not into the centre. Therefore, soaking does not turn them into “Waxy” potatoes. This additional moisture uptake offsets for the subsequent moisture losses incurred during frying and cooking in the oven. For example, the moisture absorbed during a one hour soak time leads to an increase in moisture of between 5% to 10% which is enough to offset for the moisture losses incurred during frying and in the oven and still end up at the target rate of 55% to 70% out of the oven.

The water is chilled, preferably having a temperature of less than 25° C., preferably less than 20° C. or less than 15° C. or less than 10° C. Still preferred, the water has a temperature of from −5° C. to 20° C., notably, from 10° C. to 25° C., or 15° C. to 20° C., or from −5° C. to 10° C., or from −2° C. to 8° C., or −2° C. to 5° C., or 0° C. to 2° C. Preferably, there are no additional additives, or added components, in the water. Still further benefits to soaking the raw strips are to allow excess starch to leach out and to open their cell structure. The starch inhibits the moisture from escaping during par-frying while the opening of the cell structure enables the chips to absorb more of the beef fat/coconut oil during the par-frying phase, which gives the par-fried chip an enhanced flavour. Soaking also increases the surface texture of the strips which results in the strip holding its shape during the frying stage and helps the par-fried chip to form a crispy texture when subjected to the high convection air currents in the oven.

Soaking also helps to ensure that the chips are crispy when taken out of the oven, as soaking leaches out excess starch which inhibits crust formation in the oven. Soaking helps to harden the exterior surface of the chips and increases their texture so that they maintain their shape when par-fried and this helps them to form a light crispy crust when subjected to the high convection air currents in a fan oven.

In an embodiment in which the moisture content of the raw strip is for example between 80% to 85% prior to the method, i.e., its starting moisture content, the strips would still be soaked in cold water, e.g., fora minimum of 10 minutes or 20 minutes, to increase the moisture content and for the other reasons outlined, i.e. leaching starch and increasing texture. In this instance, the par-frying time could be increased until the moisture level has been reduced to a post frying target rate of between 65% and 80%, preferably, 73% to 78%.

The raw potato strips are obtained from raw potatoes with a moisture content in a range of 70% to about 85%, typically from about 71% to about 84%, or about 72% to about 83%, about 75% to 82%, preferably with a moisture content in a range of 76% to about 81%, or 77% to 80% or most preferably with a moisture content of 78% to 79%. The preferred variety of potatoes to be used are the Markie variety (species Solanum tuberosum L. cv. Markies) but it will be appreciated that other varieties with relatively high dry matter contents would be suitable. For example, Markies, (“Markies potatoes”), Maris Piper, King Edward, Accord, Agria, Cabaret, Challenger, Performer, Russet Burbank and Victoria. Preferably, the potato strips are from Markies potatoes. All such potatoes are known in the art to the person skilled in the art.

These varieties of potato, typically referred to as “mealy or floury” varieties, in particular are low in sugar which means that they can be fried long enough to cook fully in the centre without burning the outside resulting in fluffy and moist chips on the inside. These potatoes have a relatively high starch by weight, e.g., 22% (Mccomber, Diane & OSMAN, ELIZABETH & LOHNES, ROBERT. (2006). Factors Related to Potato Mealiness. Journal of Food Science. 53. 1423-1425. 10.1111/j.1365-2621.1988.tb09291.x).

The amount of raw potato strips may be any amount. It is typically a plurality of potato strips. Typically, the raw potatoes are washed, peeled, and cut into strips, or “chips” of a desired size and shape prior to step (i). Typically, the size of the strips are 12 mm×14 mm, 14 mm×14 mm and/or 18×14 mm but the preferred size is the size 14 mm×14 mm, as this is symmetrical in width and thickness making to easier to uniformly regulate their levels of moisture. The strip may be spiral cut, crinkle cute or straight cut or any other suitable shape. It will be appreciated that any size and shape may be used.

Prior to step (i) of the method, the strips may be rinsed with water. Rinsing may be by any suitable means, for example spraying the strips with water, or jets of water. This step removes surface starch from the cutting stage/process.

Once step (i) is complete, the strips may be rinsed. Rinsing may be by any suitable means, for example spraying the strips with water, or jets of water. This step removes the starch from the surface as this can lead to them forming a thick skin or hard crust in the fryer.

The strips may then be dried prior to par-frying. Typically, the excess water is removed from the surface of the strip by blowing by any suitable means. For example, the strips are passed under an air knife/blade at room temperature to blow excess water off their surface. The surface of the strips may be air dried at room temperature. The drying step may be a combination of removing excess water by blowing and preferably left to dry at room temperature. It may be for any suitable amount of time to complete the desired result, for example about 5 minutes to about 60 minutes, or about 10 minutes to about 30 minutes, or about 20 minutes.

The potato strips are par fried in beef dripping but it will be appreciated that any suitable oil or fat may be used as a frying medium including, but not limited to, lard, sunflower oil, coconut oil, cottonseed oil, soybean oil, corn oil, palm oil, canola (rapeseed) oil, fish oil, safflower oil, peanut oil.

In order to achieve the same flavour and taste as chips served from a traditional fast food restaurant, the current method preferably includes a step of par frying the chips in beef dripping. 100% Pure Coconut Oil can be used as a vegetarian option and it has been found to work very well as it has similar properties to Beef Dripping as it is also solid a room temperature. The beef dripping is preferably pure unrefined beef dripping. The par-frying time is adjusted depending on the moisture level of the strips/chips being par-fried to reach a target moisture level of 70% to 85%, preferably 73% to 78%. The temperature of the par-frying is typically in a range of 125° C. to 165° C., or 155° C., preferably from 130° C. to 150° C., or 120° C. to 140° C., e.g., 135° C. A temperature within this range, is hot enough to cook the inside of the chip but not hot enough to form a crust on the exterior surface. This helps to maintain the texture and shape as much as possible which helps to crisp the chip in the oven. Par-frying at this temperature allows for the opening up the cell structure to absorb the beef dripping/coconut oil which gives them the desired flavour and the beef dripping/oil that remains on the surface of the chip once cooled is then further absorbed during the final oven cooking stage.

The final par-fried chip has a moisture level of in a range of from about 65% to about 85%, or 67% to 83%, or 69% to 81%, or 70% to 80%, or 71% to 79%, or 73% to 77%, or 74%. to 75%. This makes an allowance for an anticipated average moisture drop of approximately 14% during the final cooking stage in the over. This ensures that the chips once cooked, have a moisture level of from 55% to 70%, or 58 to 68%, or 60% to 65%, preferably about 58% to 63%. The inventors have identified this as the optimum range for fluffy and moist interior.

Par-frying is for approximately 2 to 10 minutes, or 3 to 8 minutes, or 4 to 6 minutes, typically about 5 minutes.

After par-frying the chips are cooled to a temperature in a range of from about −2° C. to about 10° C. The temperature may be from 0° C. to about 8° C., 2° C. to 6° C. from about 3° C. to about 5° C. The strips tend to have a core temperature of between 83° C. and 88° C. after par-frying.

The method of the invention does not include a step of blanching, dehydration, or other means of forced hot air drying, to reduce moisture levels.

In an embodiment, the par-fried chips are blast chilled. This step locks in the remaining moisture along with the flavour whilst retaining texture and colour.

Alternatively, or in addition, the par-fried chips may be frozen.

In a preferable embodiment, the chips are agitated gently during cooling so that they do not stick together as the beef dripping/coconut oil starts to solidify as it cools down. Preferably, the chips are cooled sufficiently to a point where the beef dripping is fully solid or dry on the surface of the par-fried chips, e.g. less than 20° C. such as less than 10° C. Otherwise this causes issues with moving the chips though weighing and packaging equipment if the beef dripping is still tacky or sticky. Furthermore, if the beef dripping is not totally solid and still tacky prior to packaging it would result in the chips sticking together inside the pack as they cool further in cold storage. This would then form a solid mass of chips and fat and the chips would require manual separation prior to placing them on a baking tray. This would inevitably lead to breakage of the chips and give the customer a poor initial experience of the product.

The chips are typically packaged in a sealed pre-made pouch, preferably which is gas flushed with 100% Food Grade Nitrogen to reduce the residual Oxygen content inside the pack to below 3%. This ensures that a minimum shelf life of 21 days can be achieved without suffering any loss of quality.

The par-fried chips are to be cooked in the oven by the user/customer. Alternatively, the par-fried chips may be fried. Any suitable frying method may be used, such as but not limited to deep frying, or air frying. Preferably, the par-fried chips are cooked in a fan oven at 220° C. for at least 15 minutes. The high temperature combined with sufficient air movement from the fan is sufficient to crisp up the outside of the chips within a 15-minute period. The forced air in a fan oven helps to crisp up the exterior of the chips using convection air currents that removes the moisture from the surface as it is escapes from the centre of the chips as the inside cooks. The method of the invention may further comprise this step.

Typically, when chips are cooked in an oven they are placed on a baking tray and are then subjected to convection heating on both of the sides and on the top surface but the bottom surface is subjected to conductive heating as it sits directly on the tray. This would cause the bottom surface to cook faster and burn and stick to the tray along with loosing moisture at a much faster rate that the top and the sides causing the chip to dry out. For this reason, the chips are packaged with a baking sheet. The baking sheet is a sheet of double sided non-stick siliconised greaseproof paper. The sheet is placed on top of the baking tray and the chips are spread out evenly on top of the sheet. The sheet does not allow the chips to stick to the baking sheet therefore the fat and escaping moisture can run out from under the chips allowing the bottom surface to crisp up.

In one embodiment, to produce even coloured chips it is necessary to ensure that raw potatoes contain no more than 0.25% sugar, for example 0.1 to 0.2% sugar. When a potato becomes chilled in cold weather through either being stored at very low temperature, on a cold floor or in a draught, the potato undergoes a change that converts some of its starch to sugar to provide energy to combat the cold. Therefore, it will be appreciated that the sugar content can be manipulated. Potatoes affected this way, when chipped and fried will turn dark brown in colour. This is called caramelisation. The resulting chips will also taste sweet and will soon become soggy. They may also damage the frying medium and require the oil/fat to be changed. The colour standard that is used worldwide for the evaluation of chip fry colour is the USDA French fry colour. The term fry colour, as used in this standard refers to the colour change which occurs in the potato units solely because of the frying process. In an embodiment, the target fry colour for par fried chips produced by this method is 0-00.

The method of the invention avoids the need for ultrasonic treatment, leaching and/or ion blanching and so in an embodiment does not comprise one or more of these treatments.

The invention will now be described with reference to specific Examples. These are merely exemplary and for illustrative purposes only: they are not intended to be limiting in any way to the scope of the monopoly claimed or to the invention described. These examples constitute the best mode currently contemplated for practicing the invention.

### EXAMPLE 1

### Method of Preparing a Par-Fried Chip

The raw potato strips were obtained from raw potatoes with a moisture content of 78%. The variety of potatoes used was the Markie variety (species Solanum tuberosum L. cv. Markies).

The raw potatoes were washed, peeled and cut into strips of the size 14 mm×14 mm. The strips were immersed in water for 60 minutes to achieve a moisture content of approximately 85%. The chips were rinsed with water and par-fried in beef dripping at 135° C. for approximately 5 minutes. The final moisture content of the par-fried chip was approximately 73%. The par-fried chip was then blast chilled to approximately 8° C. and packaged.

### EXAMPLE 2

### Method Validation and Product Analysis

### Process Analysis Summary

To measure the quality parameters throughout the production process for both:
Test Group 1: Freshly cut chips that are par cooked and then flash fried as they would be in a traditional chip shop.
Test Group 2: Fresh oven chips that are par cooked, cooled, stored and then placed in the oven.

### Process Optimisation Summary

To measure the quality parameters throughout while varying the production process;
Test Group 3: Preserve the quality immediately post frying using a blast chiller.
Test Group 4: To determine if a shorter frying time can produce better quality chips.
Test Group 5: To determine if more fat can be absorbed by the chips during the deep fry.
Test Group 6: To determine if the texture is affected when the soak time is shortened.
Test Group 7: To determine if the texture is affected with no soaking.
Test Group 8: To determine if the texture is affected when chips are not dried before frying.
Test Group 9: To determine if more fat can be absorbed by the chips using a higher fry temp.

### Sensory Analysis Summary

To assess the sensory acceptability of;
1. Control (test group 1)
2. The best oven cooked chip compared to control (test group 3)
3. Chips cooked using a higher fry temp (test group 9)

### Materials

Vacuum packed fresh cut chips as prepared by the method of the invention, baking paper and Frytex (beef dripping).

### Methodology

### Cooking Methods

Oven cooked chips were cooked on baking paper at 220° C. in a pre-heated Zanussi oven

(Zanussi Professional, Italy).

Fried chips were cooked in a Zanussi fryer (Zanussi Professional, Italy) in Frytex.

### Chilling Method

Par fried chips were placed on a tray and chilled in a Blast chiller (Cross Refrigeration Ltd) for 1 hour 45 minutes until a temperature of 3° C. was reached.

### Compositional Analysis

For raw chips and potatoes, moisture was determined gravimetrically following storage of samples in an oven at 105° C. for 3 hours. Dry matter was calculated by subtraction from 100.

For cooked chips, fat and moisture were determined using the SMART Trac and CEM Analysis System (CEM Corporation, USA). The CEM SMART SYSTEM provides a rapid method for the determination of moisture and fat on a broad range of products. The SMART system has a microwave chamber delivering 250 W when programmed to 100% power. This chamber has an integrated analytical balance and computer. A second unit is the SMART Trac Fat analysis system, combining microwave drying with nuclear magnetic resonance (NMR) to accurately measure fat content of any food product.

Results are expressed as %.

### Texture Analysis

Chips were sheared using a Texture Analyser TA-XT2 (Stable Micro Systems, Surrey, UK) attached with a Warner Bratzler V-shaped shearing device.

Results are expressed as grams.

### Colour Analysis

The colour of the surface of the chips was measured using a Minolta Chromameter CR-300 (Minolta Camera Co., Osaka, Japan).

Lightness and yellowness are reported.

Sensory Analysis A 10-member panel was used to evaluate the chips using a 10 point hedonic scale. Chips were labelled with a three-digit random numbers and served in triplicate. The tested attributes included; Appearance (0=extremely dislike, 10=extremely like), Texture (0=extremely dislike, 10=extremely like), Flavour (0=extremely dislike, 10=extremely like), Overall sensory acceptability (0=extremely dislike, 10=extremely like), Colour (0=light, 10=dark), Fluffiness—inside of chip (0=none, 10=extreme), Crispiness—outside of chip (0=none, 10=extreme).

### Results

### Process Analysis—Test Group 1 & 2

Test group 1 (Control) represents freshly cut chips that were par cooked and then flash fried as they would be in a traditional chip shop. These chips were the control referenced by all other tests as this was what we were trying to achieve with the oven chips.

Test group 2 represents the fresh oven chips that were par cooked, cooled, stored overnight and then placed in the oven. The par cooked chips are those produced by the method of the current invention.

Sample numbers are those of Table 1. The results showed that the dry matter and moisture contents (sample number 1001 & sample number 2001) of the raw potatoes were extremely close and were typical values for potatoes that are used to produce good quality chips. The initial moisture content of the fresh cut chips rinsed with water was ˜81% (sample numbers 1002 & 2002).

TABLE 1
Results for Process Analysis.

| | | | | | Test Matrix | | | | | |
|---|---|---|---|---|---|---|---|---|---|---|
| | | | | | Dry | | | Fat | | |
| Test | Process | | | Sample | Matter | Moisture | Texture | Content | Yellow- | Light- |
| Group | Stage | Duration | | No. | (%) | (%) | (g) | (%) | ness | ness |
| 1 | Raw Potatoes | — | | 1001 | 21.27 | 78.72 | | | | |
| | Fresh Cut Chips | — | | 1002 | | 80.99 | 3094.48 | 0 | 24.94 | 66.72 |
| | rinsed with water | | | | | | | | | |
| | Post Soaking in Water | 1 | Hour | 1003 | | 84.61 | 3288.16 | | | |
| | Post Drying at Room Temp | 1 | Hour | 1004 | | 80.54 | 3622.28 | | 26.27 | 66.07 |
| | Post Frying at 135 deg C. | 5 | minutes | 1005 | | 75.28 | 1247.29 | 1.13 | 18.75 | 68.43 |
| | Cooled to room temperature | 1 | Hour | 1006 | | 72.99 | 1347.16 | | 18.32 | 68.92 |
| | Flash Fried at 180 deg C. | 3 | minutes | 1007 | | 63.92 | 408.11 | 3.79 | 24.94 | 68.51 |
| 2 | Raw Potatoes | — | | 2001 | 21.12 | 78.88 | | | | |
| | Fresh Cut Chips | | | 2002 | | 80.96 | 3091.97 | 0 | 26.44 | 68.36 |
| | rinsed with water | | | | | | | | | |
| | Post Soaking in Water | 1 | Hour | 2003 | | 84.88 | 3355.18 | | | |
| | Post Drying at Room Temp | 1 | Hour | 2004 | | 80.74 | 3579.79 | | 25.38 | 67.56 |
| | Post Frying at 135 deg C. | 5 | minutes | 2005 | | 75.54 | 1271.3 | 1.13 | 18.19 | 67.98 |
| | Post Free Cooling | 2 | hours | 2006 | | 71.47 | 1275.08 | | 16.65 | 68.82 |
| | to room temp | | | | | | | | | |
| | Post refrigeration overnight | 12 | hours | 2007 | | 70.41 | 1317.77 | | 17.94 | 73.62 |
| | to 3 deg C. | | | | | | | | | |
| | Post Cooking in Fan Oven | 15 | minutes | 2008 | | 56.74 | 831.39 | 2.23 | 29.39 | 72.61 |
| | at 220 deg C. | | | | | | | | | |

The 1-hour soaking period increased the moisture content by around 4% (sample numbers 1003 & 2003). However, the 1 hour drying period reduced the moisture content back down to ˜80.5% (sample numbers 1004 & 2004). After the par frying step at 135° C. for 5 minutes, moisture was reduced in both cases to ˜75% (sample number 1005 & 2005). The moisture content of chips cooled to room temperature for 1 hour (sample number 1006) decreased to 72.99%. Chips cooled to room temperature for 2 hours (sample number 2006) decreased to a moisture content of 71.47% and were further stored overnight for 12 hours at 3° C. (sample number 2007) reducing the moisture again to 70.41%.

The final cooking phase for the control fried chips (sample number 1007) reduced the moisture content to 63.92% which is a total of 9.07% moisture loss in the final cooking stage. However, the final cooking phase for the oven chips (sample number 2008) reduced the moisture content by 13.67% resulting in a significantly lower final moisture content of 56.74%.

This was due to the difference in the cooking methods applied; oven cooking employs heat at a higher temperature for a much longer time therefore resulting in higher moisture loss and a dryer end product.

In regard to texture, fried chips (sample number 1007) required a lower force to shear the chip indicating a softer, fluffier chip. Oven cooked chips (sample number 2008) required a significantly higher force indicating a harder, drier chip.

The fat content of the chips after the par frying step was 1.13%. After frying (sample number 1007) this value increased the fat content to 3.79%. For oven cooked chips (sample number 2008), the final fat content was lower at 2.23%. Finally, the fried chips (sample number 1007) were slightly darker and less yellow than the oven cooked chips (sample number 2008).

Process Optimisation—Test group 3

Results are outline in Table 2.

TABLE 2
Results for Process Optimisation.

| | | | | | | Test Matrix | | | | | |
|---|---|---|---|---|---|---|---|---|---|---|---|
| | | | | | | Dry | | | Fat | | |
| Test | | Process | | | Sample | Matter | Moisture | Texture | Content | light- | yellow- |
| Group | Reference | Stage | Duration | | No | % | % | g | % | ness | ness |
| 3 | Blast chill | Raw Potatoes A | | | 3001 | 21.58 | 78.42 | | | | |
| | | Raw Potatoes B | | | | 19.91 | 80.09 | | | | |
| | To try and | Fresh Cut Chips | | | | | | | | | |
| | preserve the | rinsed with water | | | | | | | | | |
| | quality immediately | Post Soaking in Water | 1 | Hour | | | | | | | |
| | post frying, ie. | Post Drying at Room Temp | 1 | Hour | | | | | | | |
| | moisture and | Post Frying at 135 deg C. | 5 | minutes | 3002 | | 76.44 | 1209.27 | 1.27 | 67.78 | 18.92 |
| | colour | Post Blast Chill to 3 deg C. | 1 hr 45 mins | | 3003 | | 75.35 | 1462.27 | | 70.63 | 20.56 |
| | | [symbol] ost Cooking in Fan Oven | 15 | minutes | 3004 | | 61.23 | 853.96 | 2.85 | 72.34 | 29.51 |
| | | at 220 deg [symbol] | | | | | | | | | |
| 4 | Shorter Fry time | Raw Potatoes | | | | | | | | | |
| | From experience, | Fresh Cut Chips | | | | | | | | | |
| | as the Dry Matter | rinsed with water | | | | | | | | | |
| | of these potatoes is | Post Soaking in Water | 1 | Hour | | | | | | | |
| | perfect then the | Post Drying at Room Temp | 1 | Hour | | | | | | | |
| | shorter frying time | Post Frying at 135 deg C. | 4 | minutes | 4001 | | 76.52 | 1195.79 | 0.78 | | |
| | seems to produce | Post Blast Chill to 3 deg C. | 1 hr 45 mins | | 4002 | | 76.18 | 1266.54 | | | |
| | | [symbol] ost Cooking in Fan Oven | 15 | minutes | 4003 | | 59.22 | 974.98 | 2.48 | | |
| | | at 220 deg [symbol] | | | | | | | | | |
| 5 | Higher fry temp | Raw Potatoes | — | | | | | | | | |
| | To see if we can | Fresh Cut Chips | | | | | | | | | |
| | get more fat into | rinsed with water | | | | | | | | | |
| | them during the | Post Soaking in Water | 1 | Hour | | | | | | | |
| | only deep fry | Post Drying at Room Temp | 1 | Hour | | | | | | | |
| | | Post Frying at 180 deg C. | 4 | minutes | 5001 | | 64.4 | 465.79 | 3.03 | | |
| | | Post Blast Chill to 3 deg C. | 1 hr 45 mins | | 5002 | | 64.92 | 580.01 | | | |
| | | [symbol] ost Cooking in Fan Oven | 15 | minutes | 5003 | | 46.16 | 1981.86 | 5.26 | | |
| | | at 220 deg [symbol] | | | | | | | | | |
| 6 | Shorter Soak time | Raw Potatoes | — | | | | | | | | |
| | To see if the | Fresh Cut Chips | | | | | | | | | |
| | texture is affected | rinsed with water | | | | | | | | | |
| | | Post Soaking in Water | 15 | mins | 6001 | | | 3517.59 | | | |
| | | Post Drying at Room Temp | 1 | Hour | 6002 | | 79.63 | 3962.89 | | | |
| | | Post Frying at 135 deg C. | 5 | minutes | 6003 | | 74.69 | 967.28 | 1.07 | | |
| | | Post Blast Chill to 3 deg C. | 1 hr 45 mins | | 6004 | | 74.4 | 1035.99 | | | |
| | | [symbol] ost Cooking in Fan Oven | 15 | minutes | 6005 | | 56.04 | 1548.88 | 2.92 | | |
| | | at 220 deg [symbol] | | | | | | | | | |
| 7 | No Soak | Raw Potatoes | — | | | | | | | | |
| | To see if the | Fresh Cut Chips | | | | | | | | | |
| | texture is affected | rinsed with water | | | | | | | | | |
| | | Post Soaking in Water | 0 | mins | | | | | | | |
| | | Post Drying at Room Temp | 1 | Hour | 7001 | | 75.67 | 3437.19 | | | |
| | | Post Frying at 135 deg C. | 5 | minutes | 7002 | | 75.10 | 700.39 | 0.93 | | |
| | | Post Blast Chill to 3 deg C. | 1 hr 45 mins | | 7003 | | 73.13 | 863.40 | | | |
| | | [symbol] ost Cooking in Fan Oven | 15 | minutes | 7004 | | 52.62 | 1766.01 | 3.06 | | |
| | | at 220 deg [symbol] | | | | | | | | | |
| 8 | Not dried before | Raw Potatoes | — | | | | | | | | |
| | frying | | | | | | | | | | |
| | To see if the | Fresh Cut Chips | | | | | | | | | |
| | texture is affected | rinsed with water | | | | | | | | | |
| | | Post Soaking in Water | 15 | mins | | | | | | | |
| | | Post Drying at Room Temp | 0 | min | | | | | | | |
| | | Post Frying at 135 deg C. | 5 | minutes | 8001 | | 75.78 | 646.12 | 1.51 | | |
| | | Post Blast Chill to 3 deg C. | 1 hr 45 mins | | 8002 | | 74.25 | 686.95 | | | |
| | | [symbol] ost Cooking in Fan Oven | 15 | minutes | 8003 | | 59.30 | 1488.67 | 2.45 | | |
| | | at 220 deg [symbol] | | | | | | | | | |
| 9 | Higher fry temp | | | | | | | | | | |
| | To get more fat | | | | | | | | | | |
| | into them and see if | Post Soaking in Water | 2 | Hour | | | | | | | |
| | sensory panel | Rinse with Cold Water | | | | | | | | | |
| | prefer them | Post Drying at Room Temp | 1 | Hour | | | | | | | |
| | | Post Frying at 160 deg C. | 2.5 | minutes | 9001 | | 72.84 | 857.03 | 1.41 | | |

| Post Blast Chill to 3 deg C | 1 hr 45 mins | | 9002 | 73.02 | 971.49 | |
|---|---|---|---|---|---|---|
| [symbol] ost Cooking in Fan Oven | 15 | minutes | 9003 | 59.07 | 1404.46 | 3.04 |
| at 220 deg [symbol] | | | | | | |

[symbol]

indicates data missing or illegible when filed

More potato samples (A & B, sample number 3001) were provided for dry matter content analysis. Potatoes A had a similar dry matter content (˜21%; ˜79% moisture content) as previous samples 1001 and 2001. Potatoes B had a lower dry matter content of 19.91% (80.09% moisture content) but were not used for further analysis.

In this test group, the overnight refrigeration step was replaced with the blast chill step to try and preserve the quality immediately post frying i.e. moisture and colour. Before analysis was carried out, it was pre-determined using a handheld temperature probe that the chips would take 1 hour 45 minutes post frying to reach 3° C. in the blast chiller.

After blast chilling (sample number 3003), the moisture content was 75.35% which is a 5% increase compared to samples which were refrigerated overnight (sample number 2007). As a result, after oven cooking (sample number 3004), the final moisture content was 61.23% which is a 4.5% moisture increase compared to the end product of test group 2 (sample number 2008) and this value is significantly closer to the moisture content of the control (test group 1) which was 63.92% (sample number 1007).

The texture and colour were not affected by the blast chilling step and values remained similar to those of test group 2 throughout the process. The final fat content increased from 2.23% (sample number 2008) to 2.85% (sample number 3004) which was closer to the control fat content of 3.79% (1007).

In summary, blast chilling increased both the moisture and fat contents which are both closer to the control sample. However, the colour and texture did not change.

### Process Optimisation—Test Group 4

In this test group the par frying time was shortened from 5 minutes to 4 minutes to determine if the quality could be improved. Post frying (sample number 4001) the moisture was only slightly higher than (<1%) than test group 3 (sample number 3003). As the par frying step was shortened from 5 minutes to 4 minutes, less fat was absorbed into the chips during this step (0.78%), as a result the final fat content was also lower (2.48%) than test group 3 (sample 3004) which was 2.85%. The final moisture content (sample 4003) was also 2% lower than test group 3 (sample 3004) which could be due to the lower fat content of sample 4001. The values for texture were higher than in test group 3 which was due to the lower final moisture content resulting in a slightly harder and drier chip.

In summary, 5 minutes of par frying results in a chip of better quality in terms of texture and also fat and moisture content.

### Process Optimisation—Test Group 5

In this test group a higher fry temperature of 180° C. was employed for 5 minutes to determine if it was possible to get more fat into the chips during the deep fry. The results showed that the higher fry temperature resulted in sample 5001 containing 3% fat, 64% moisture with a shear force value of 465.8 g which are all extremely close to the final control product (sample 1007—test group 1) therefore after the par frying step at 180° C. these samples are already close to the optimum.

The final oven cooking step resulted in a dry (46% moisture) and hard (1981.9 g shear force) chip with a higher fat content (5.26%) compared to control samples (test group 1).

In summary, although the higher par frying temperature significantly increased the fat content, it resulted in an overcooked, dry and hard final product.

### Process Optimisation—Test Group 6, 7 & 8

In test group 6 the soaking time was shortened from 1 hour to 15 minutes in order to determine if the texture is affected. In test group 7 the soaking step was removed completely to determine if the texture was affected. In test group 8 the chips were not dried before frying to determine if the texture was affected.

Test group 7 (no soak) resulted in the worst quality chips in terms of moisture and texture and Test group 8 (not dried before frying) resulted in chips closest to the control (test group 1) in terms of moisture content (59.3%).

In all three test groups, the chips were initially softer after par frying and then significantly increased in hardness/texture after oven cooking. Reducing the soaking and drying times may have increased the hard outer crust of the chips due to the interaction between the starch molecules and water.

In summary, varying the soaking and drying times had a negative effect on quality parameters.

### Process Optimisation—Test Group 9

In test group 9 the chips were soaked for longer (2 hours), rinsed with cold water and fried at a higher temperature (165° C.) for a shorter time (2.5 minutes) to determine if it is possible to get more fat into the chip and see how the texture was affected.

The results showed par frying at the higher temperature for a shorter time increased the fat of sample 9001 to 1.41% and the final fat content (sample number 9003) to 3.04%. However, the moisture content was lower both after par frying (sample number 9001) and in the final product (sample number 9003) and the texture was also negatively affected.

In summary, although employing a higher temperature for a shorter time increases the fat content, it has negative effects on the moisture and textural quality of the chips.

### Sensory Results

The results of the sensory analysis showed that in terms of appearance, test group 9 was the least preferred which may be due to the drier, more ‘cooked’ appearance. The panellists very slightly preferred the appearance of the control chips (test group 1) compared to test group 3.

For Texture, again, test group 9 were the least preferred possibly due to the harder, drier texture of the chips. The control chips were the most preferred in terms of texture; however, test group 9 were also very close to control samples.

Control samples were preferred the most in regard to texture, which was expected due to the higher fat content compared to test group 3. Although test group 9 had a higher fat content in comparison to test group 3, the panellists preferred the flavour of test group 3 which may be related to the higher moisture content of the chips.

Control samples were perceived to be the darkest, followed by test group 9 and then test group 3; however, small differences between these values indicate the colour differences were not significantly noticed.

Control samples were the fluffiest, test group 3 were in the middle and test group 9 were the least fluffy. These findings correspond with the instrumental values for moisture for all these test groups.

In terms of crispiness, test group 9 were the crispiest, followed by test group 3, and control samples were the least crispy. These findings also correspond with the instrumental values for texture for all these test groups.

Overall, test group 9 was the least acceptable sample due to the appearance, texture, fluffiness and crispiness. Although control samples were the most preferred in terms of flavour and fluffiness, the panellists seemed to prefer the crispiness of test group 3 and as a result scores for OSA (overall sensory acceptability) were extremely close between these two test groups.

### Conclusions

Overall, test group 3 (adding blast chilling and leaving all other process parameters as they are) resulted in the best quality oven chip and in terms of OSA the sensory panel only slightly preferred the control fried chips to these optimised oven chips (test group 3).

### Equivalents

The foregoing description details presently preferred embodiments of the present invention. Numerous modifications and variations in practice thereof are expected to occur to those skilled in the art upon consideration of these descriptions. Those modifications and variations are intended to be encompassed within the claims appended hereto.

1. A method of producing a par-fried chip with a moisture content in a range of 65% to 85%, the method comprising the steps of:
(i) immersing an amount of raw potato strips having a moisture content in a range of from 70% to 85% in water with a temperature of 25° C. or less, for at least 15 minutes to increase the moisture content by at least 2%
(ii) par-frying the strips to achieve a par-fried chip with a moisture content in a range of from 65% to 85%.

2. The method of claim 1, wherein the raw potato strips are untreated with additives, flavourings and/or preservatives.

3. The method of claim 1 or 2, wherein the method does not comprise a step of blanching.

4. The method of any one of the preceding claims, wherein the moisture content of the raw potato strip in step (i) is in a range of from about 75% to 83%.

5. The method of claim 4, wherein the moisture content of the raw potato strip is in a range of about 73% to 78%

6. The method of any one of the preceding claims, wherein the strips in step (ii) are par-fried in oil at a temperature from about 125° C. to 165° C.

7. The method of claim 6, wherein the strips are par-fried at a temperature from about 130° C. to 150° C.

8. The method of any one of the preceding claims, wherein the strips of step (ii) are par-fried for about 2 to 10 minutes.

9. The method of claim 8, wherein the strips are par-fried for about 5 minutes.

10. The method of any one of the preceding claims, in which the water in step (i) has a temperature in a range of from about −5° C. to 10° C.

11. The method of any one of the preceding claims, for producing a par-fried chip with a moisture content of about 70% to 85%.

12. The method of any one of the preceding claims, wherein the potato strips are from potatoes selected from the group comprising the species Solanum tuberosum L. cv. Markies, (“Markies potatoes”) Maris Piper, King Edward, Accord, Agria, Cabaret, Challenger, Performer, Russet Burbank and Victoria.

13. The method of any one of the preceding claims, wherein in step (i) the strips are immersed in water for at least 15 minutes to increase the moisture content by 2% to 15%.

14. The method of claim 13, wherein the strips are immersed in water for at least 30 minutes to increase the moisture content by 2% to 15%.

15. The method of any one of the preceding claims, wherein the strips are rinsed with water prior to step (i).

16. The method of any one of the preceding claims, wherein the strips are rinsed with water prior to step (ii).

17. The method of any one of the preceding claims, wherein the surfaces of the strips are dried prior to step (i)

18. The method of any one of the preceding claims, further comprising a step of cooling the chips to a temperature in a range of between about −2° C. and 10° C.

19. The method of claim 18, in which the chips are blast chilled.

20. The method of claim 18 or 19, wherein the chips are agitating during cooling.

21. The method of any one of claims 1 to 20, further comprising a step of freezing the chips.
